(19) United States
(12) Patent Application Publication
(10) Pub. No.: US 2003/0029104 A1
(43) Pub. Date: Feb. 13, 2003

(54) Releaseable locking window-mounting device for insulated doors

(76) Inventor: Kenneth E. Leonard, Warren, OH (US)

Correspondence Address: Robert G. Lev, 4766 Michigan Boulevard, Youngstown, OH, 44505, US

(21) Appl. No.: 09/928,910

(22) Filed: Aug. 13, 2001

(51) Int. Cl. E06B 3/00

(52) U.S. Cl. 52/208

(57) ABSTRACT

A mounting device for holding a first panel within an aperture in a second panel includes two frames. The first frame has connector studs with teeth extending across the width of each connector stud. The second frame contains complementary hollow receivers with latching structures for holding onto the teeth and effecting a permanent connection holding the two frames together. The frames, the connector studs and the hollow receivers are all flexible in order to facilitate easy connections of the two frames, and accommodate various types of stress.

### TECHNICAL FIELD

The present invention relates generally to devices for mounting panes such as windows or other structures such as instrument faces within apertures in walls or doors. In particular, the present invention is directed to a device for permanently or removably mounting a window in a thick, insulated garage door.

### BACKGROUND OF THE INVENTION

There are many applications requiring the use of a window to be mounted within an aperture in a panel. One of the most common is the use of windows in garage doors, or other normally solid doors. Another example is the mounting of recording instruments with glass-covered dials or displays to be arranged within apertures in solid panels or walls. Still another application is the use of decorative devices placed within apertures of panels and back-lit to further enhance the decorative qualities of the materials in the aperture.

In any of these applications the devices for holding the window (or other structure) within the aperture of the panel must be rugged and easy to use. In some instances, low cost is especially important while in other situations a pleasing or decorative appearance is essential. In still other situations, the mounting device must be impervious to atmospheric conditions, including moisture, sunlight and extremes in temperature. Unfortunately, there are certain drawbacks in the conventional art relating to the installation of windows and the like within solid panels, especially thick, insulated doors.

For example, in U.S. Pat. No. 2,645,827 to Koll, a complex cut-out is required in order to accommodate a plurality of tongues which are used to hold a mounting frame to the surrounding panel. Consequently, the mounting of windows using this system is time-consuming and difficult. Further, if the precise pattern of the notches is not achieved, there could be substantial difficulties in using the mounting frame of Koll. Because of the complexity of the cut-out pattern, mis-cuts become far more likely than with a simple aperture cut-out pattern. As a result, a mistake that could result in the destruction of the panel is likely with the Koll mounting device.

When using the device of U.S. Pat. No. 5,369,922 to Hansen, a simple aperture cut out pattern can be used, thereby avoiding the drawbacks of the Koll device. In the arrangement of Hansen, a frame member is integral with a first frame and attached to cover the core of the wall (in which a window is to be mounted). The frame member includes a plurality of pairs of ribs. Each pair is connected by a strip to form an elongated opening there between. A second frame includes a connection device consisting of elongated tongues providing with teeth and arranged in a longitudinal direction along the frame. The use of the Hansen device includes clipping together the two frames from each side of the wall (in which the window is to be mounted). The second frame, and the side teeth on each tongue cooperate with the teeth on corresponding or complementary pairs of ribs on the other frame to in order to hold the two frames together. The strength of this arrangement is that it is highly tamper resistant.

However, the mounting teeth of Hansen are located only at the edges of the tongues. Thus, the slightest distortion of the Hansen device may render it unfit for use since the alignment between the toothed tongues on one frame and elongated openings on the other frame must be very precise. Another drawback of the Hansen device is the relatively small flexible sealing lips that are used to hold the window panes. If the sealing lips are sufficiently rigid to firmly hold the window pane, a loss of flexibility occurs. Thus, the ease of use, and durability of the overall device is degraded. If, on the other hand, the relatively short sealing lips are relatively flexible, the window pane may not be held in a sufficiently firm manner, thereby leading to other difficulties.

U.S. Pat. No. 6,101,772 to Leonard et al. solves many of the aforementioned problems, and lends itself to a wide variety of variations. However, the locking mechanism of the Leonard et al. device is often very awkward to release, and may impose limitations on the relative sizes of the panels being handled by the mounting frame.

Consequently, there is still a need to provide a mounting device for releaseably locking, or permanently holding a window within a wall panel. The mounting device must be sufficiently flexible to accommodate the variations that constantly occur in the field while still sufficiently rigid to tightly hold window panes within a wall panel. In order to be useful in the field, such a device must be easy to use, and have a resilient, robust structure for which operation is not undermined by rough use or deformation occurring during the mounting process. Such a device should also be sufficiently adaptable in it's operation that it can accommodate various thicknesses of mounting panels and windows. The locking device should be easy to operate, requiring no special tools or skills.

### SUMMARY OF THE INVENTION

Accordingly, it is the object of the present invention to provide a mounting device that overcomes the drawbacks of the conventional art.

It is another object of the present invention to provide a mounting device that can be permanent and highly tamper-resistant.

It is a further object of the present invention to provide a window mounting device that is easy to use, and requires only a simple cut-out.

Still another object of the present invention is to provide a mounting device for a window or instrument that can be installed quickly and efficiently in an insulated door panel.

It is yet a further object of the present invention to provide a mounting device that can be quickly assembled by means of a simple latching engagement.

It is an additional object of the present invention to provide a mounting device that is easily adaptable to a variety of window and panel thicknesses.

It is still another object of the present invention to provide a window mounting device that easily creates a tight seal weather-proof around the window pane.

It is again a further object of the present invention to provide a mounting system capable of accommodating different structures in an aperture within a wall panel.

It is an additional object of the present invention to provide a mounting system capable of releaseable locking.

It is again a further object of the present invention to provide a mounting system which can be selected as being releaseable or permanent.

It is still another object of the present invention to provide a mounting system capable of locking a window or other structure within an aperture of a wall panel where locking and releasing of the mounting system can be carried out without special tools or skills.

It is yet an additional object of the present invention to provide a mounting system capable of using the same implement for both locking and releasing a window or other structure within an aperture of a wall panel.

These and other goals and objects of the present invention are achieved by a mounting device for holding a first panel within an aperture in a second panel. The mounting devices includes a first flexible frame having a first base structure, a first flexible holding structure extending from the first base structure and arranged to overlap the first panel. A second flexible holding structure also extends from the first base structure and arranged to overlap the second panel. A plurality of connector studs are formed on the first frame. Each of the connector studs has at least one major surface extending along an axis substantially perpendicular to the first base structure. Each of the connector studs also has a plurality of teeth each arranged across the width of the connector stud and sequentially along the length of the major surface of the connector stud. The mounting device further includes a second flexible frame having a third flexible holding structure arranged to overlap the first panel and a fourth flexible holding structure arranged to overlap the second panel. The second frame also has a plurality of hollow receivers arranged to receive a complementary connector stud from the first frame. Each of the hollow receivers has an interior latch structure arranged to interface and grip to at least one of the teeth of the complementary connector stud.

In another aspect of the present invention a mounting device for holding a first panel within an aperture within a second panel includes two flexible frames. The first flexible frame has a first flexible holding structure arranged to overlap the first panel and a second flexible holding structure arranged to overlap the second panel. The first flexible frame further has a plurality of connector studs. The second flexible frame has a third flexible holding structure arranged to overlap the first panel, and a fourth flexible holding structure arranged to overlap the second panel. The second flexible frame also has a plurality of receptacles arranged to receive complementary connector studs from the first flexible frame. The first and second flexible frames exert spring-like pressure against the first and second panels where the first and second frames are connected together by virtue of the connector studs and the receptacles.

Still another aspect of the present invention includes a mounting device for holding a first panel within an aperture in a second panel using a first flexible frame and a second flexible frame. The first flexible frame has a first base structure, holding structures that extend from the base structure for holding both the first and second panels, and a plurality of connecting studs. The second flexible frame has a second base structure and holding structures extending from the second base structure for holding the first and second panels. The second flexible frame also contains a plurality of connecting receptacles arranged to receive complementary connector studs. Each of the connecting receptacles includes a latching device for holding the complementary connector stud. The mounting device further includes an insertion device for locking and releasing the connector studs within the complementary connector receptacles.

### BRIEF DESCRIPTION OF THE DRAWINGS

FIG. 1 is a top view diagram of a first (exterior) frame constituting the present invention.

FIG. 2 is a top view diagram of a second (interior) frame, complementing the first frame.

FIG. 3 is a side cross sectional view of the frame of FIG. 2.

FIG. 4 is a detailed view of the frame of FIG. 1, including the details of one of the connecting studs.

FIG. 5 is a perspective view of an alternative mounting frame arrangement.

FIG. 6 is a side view of the FIG. 5 arrangement.

FIG. 7 is a cross sectional view of a stud from frame 10 interacting with a hollow receiver of frame 20.

FIG. 8 is a detailed view of aperture 28 and the structures contained therein.

FIG. 9 is a perspective view of a locking device.

FIG. 10 is a first cross sectional view showing the interaction of the locking device with the connector stud and latching receptacle.

FIG. 11 is a second cross sectional view, taken at 90° from that of FIG. 10, depicting the locking device and its interface with the connecting receptacle.

FIG. 12 is a expanded view of the FIG. 10 depiction of the present invention.

### DETAILED DESCRIPTION OF THE PREFERRED EMBODIMENTS

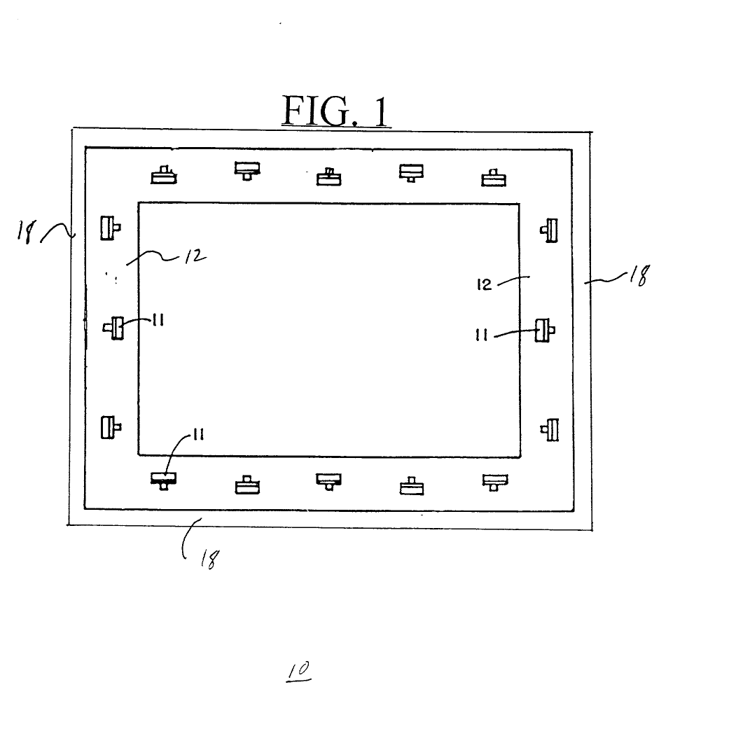

A preferred embodiment of the present invention is depicted in FIG. 1 as being rectangular in shape. This shape conforms with the most common shape of windows or other panel-like devices that are placed in wall panels, such as garage doors. However, the shape of the present invention is not limited to a rectangle. Rather, the present invention can be used in any size or shape of window or other structure which is to be mounted within an aperture formed in a panel or wall.

It should be noted that while at lease one preferred embodiment of the present invention is adapted specifically for insulated garage doors, it can be used for non or un-insulated garage doors, entry doors in dwellings (both solid and hollow core), as well as wall panels of a number of different types of materials. Also, the present invention is not limited to a pane of glass placed within a wooden or metal garage door panel, even though this may be the most common use of the present invention.

Preferably, the connecting device is made of a resilient, flexible plastic capable of holding its form. However, fiberglass can also be used, as can any metal having spring-like characteristics. The requirements for the materials constituting the present invention is that they be sufficiently rigid to laterally support a window pane within a wall panel, yet be sufficiently resilient so as to provide spring-like action on the window pane as will be described infra. Consequently, hard rubber or nylon can also be used to constitute the present invention.

Further, a combination of materials can also be used, depending upon the size of the aperture, size and constitution of the wall panel and the size and constitution of the structure to be held within the aperture. For example, the outer frame used on the exterior of the panel can be made of a rigid nylon material while the frame used on the interior of the panel can be constituted by a softer or more flexible material to better grip the window pane or other structure that is to be mounted within the aperture in the wall panel. Further, different portions of the two frames can be constituted of different materials. However, the most efficient manner of constructing the present invention is to use uniform injection-molded plastic pieces for each frame.

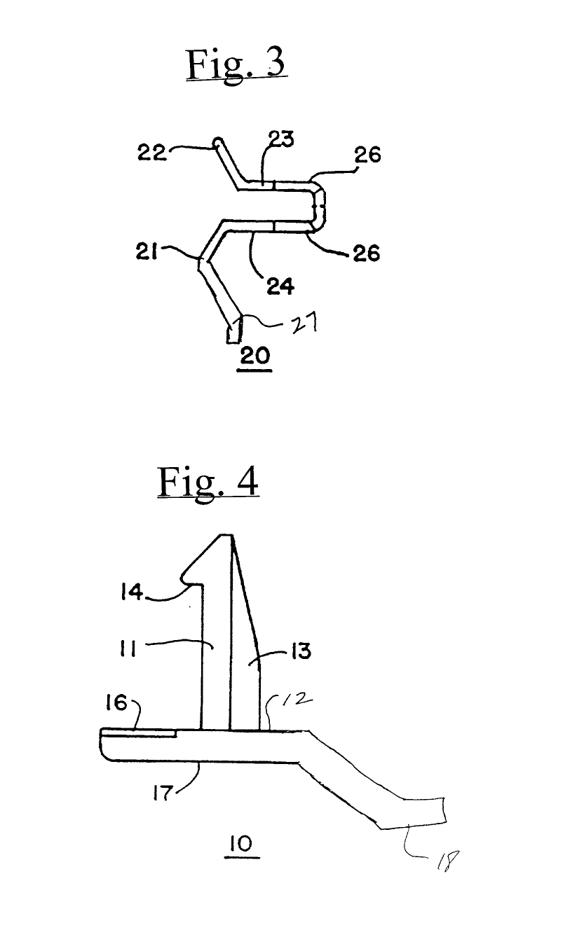

FIG. 1 depicts a top view of the inner face of an outer or exterior frame 10, that is used on the exterior side of the wall panel (not shown). The bottom surface of frame 10 is depicted as surface 17 in FIG. 4, and presents a smooth, solid, highly tamper-resistant surface for an exterior side of the wall panel in which another panel such as a window (not shown) is held by the two frames 10 and 20 of the present invention.

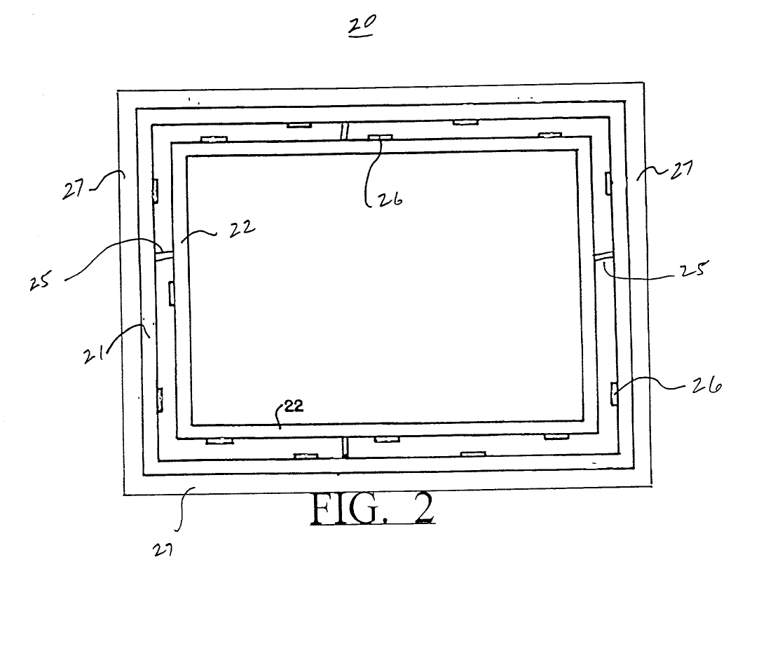

A second frame 20, depicted as a bottom view in FIGS. 2 and a side view in FIG. 3, connects to frame 10. The two frames 10, 20 sandwich both the wall panel (not shown) and the window (not shown) between them, and hold the window within an aperture in the wall panel by virtue of connections between the two frames, described infra. While frame 10 is depicted as the exterior frame for purposes of depicting one embodiment of the present invention, frame 20 can also be used on the exterior of the panel and the window.

Frame 20 matches frame 10 in size and shape. Frame 20 has connecting structures which correspond to and complement those of frame 10 as described infra. Both frames can have detents or indentations 16 to better hold both the panel and window. The indentations are easily formed in both frames 10, 20 as part of the preferred injection molding process. However, the indentations can be formed by machine, heat treatment or any other technique that would occur to a skilled practitioner having knowledge of the forming techniques for the particular material used to constitute the two frames.

Detents such as 16 (FIG. 4) may not be necessary, and can be added or deleted as dictated by the size, and characteristics of the material to be handled by the mounting frame. More important than the presence or absence of detents is the configuration of the holding structures 27, 18 on frames 20, 10 respectively. These holding structures extend from the base 17 of frame 10 (as depicted in FIG. 4), and from arm 21 of frame 20 (as depicted in FIG. 3) to better accommodate a larger panel in which a window is to be mounted. It should be understood that holding structures such as those depicted in FIGS. 3 and 4 can be extended from base 17 of frame 10 or either of the arms 21, 22 of frame 20, as needed for a particular mounting application. The present invention admits to any number of different modifications to provide the desired holding structures, such as 18 and 27. The holding structures are preferably formed as a part of each frame.

The depicted example of the outer wall frame 10 is approximately 6 inches by 8 inches for the outside dimensions. The width of each of the planar structures 12 is approximately 1.79 inches. The planer structure 12 (of frame 10) which includes the majority of the material of exterior or outer frame 10 is approximately 0.100 inch thick. It should be understood that these exemplary dimensions can be altered in any way necessary to adapt to specific panel and window sizes. Size modifications are limited only by the characteristics of the materials used to constitute the inventive mounting device, and the sizes of the two panels.

The two frames, 10,20 can be connected together by means of various types of connecting devices. Examples are the hook and aperture arrangements (14 and 26) of FIGS. 4 and 3, respectively. However, other types of connecting arrangements can be used to hold frames 10, 20 together in a manner that facilitates a spring-like action to better grip the two panels to each other. In one preferred embodiment, connector studs 11 are arranged with approximately 1 inch intervals spaced between them. However, different spacings can be used while maintaining the operating concept of the present invention.

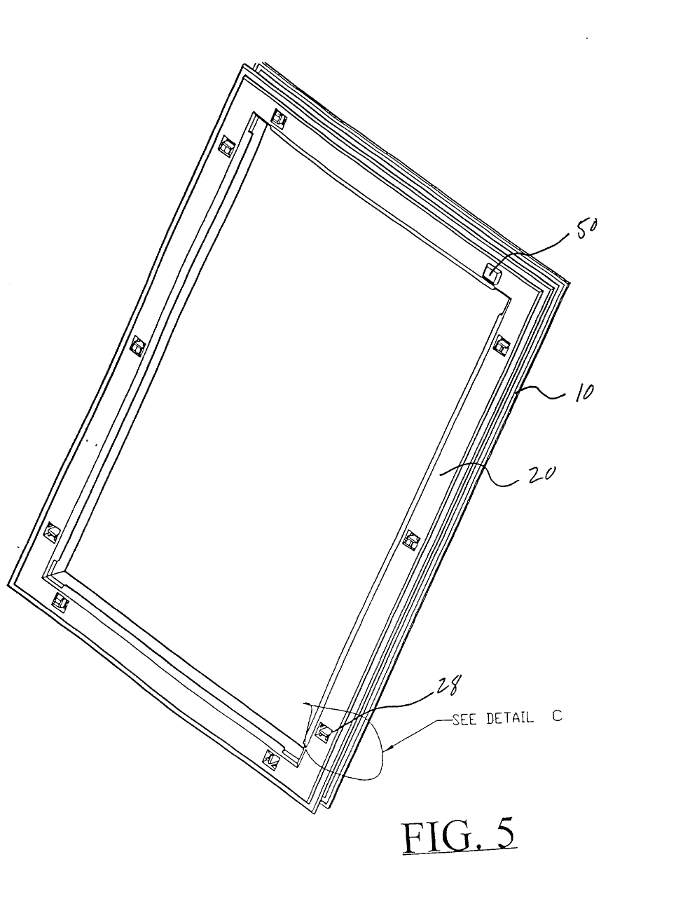

Another preferred embodiment is depicted in FIGS. 5-11. The configuration of both of the frames is very similar to that of the embodiments in FIG. 1 and 2. Accordingly, the same drawing designation numerals will be used for both embodiments where identical or very similar elements are involved. Connector studs 11 on frame 10 (of the FIGS. 5-11 embodiments) are arranged very much as they were in the FIGS. 1-4 embodiments. The base structure 12 of the second embodiment is also very similar to that of the first embodiment, as is the arrangement of surface 17. In both of the embodiments the holding structures can vary radically as is indicated by a comparison of holding structures 18, 22, and 27 between the two embodiments.

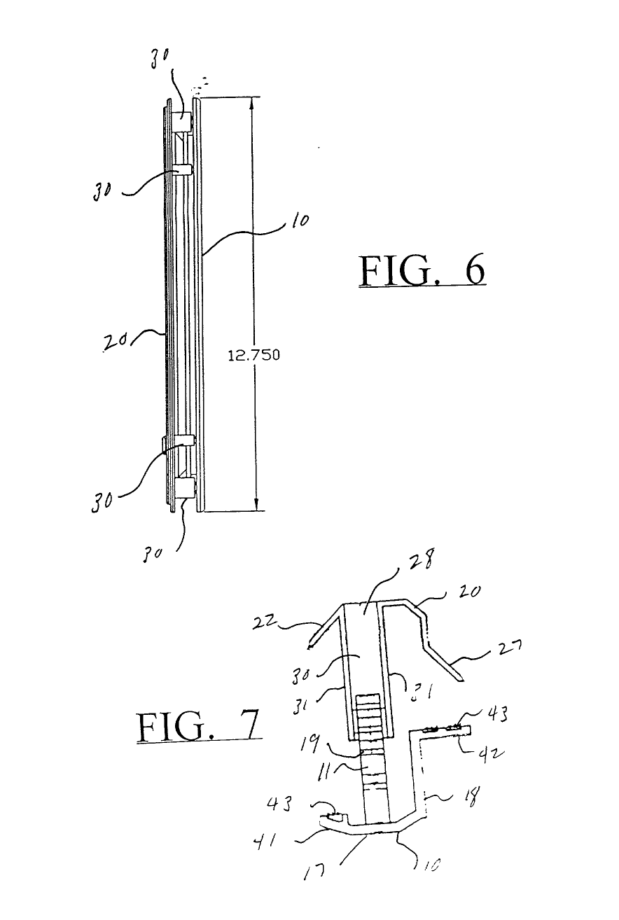

A key difference between the two embodiments is the use of hollow receptacles or receivers 30 (FIG. 7) to accept connecting studs 11. The receivers are constituted by lateral side walls 31, and a back wall 2. This arrangement when used in conjunction with the structure of aperture 28 provides a roughly rectangular hollow receptacle. The key attribute of this receptacle resides in moveable arm 32, which contains a latching device 33 to interface with the teeth 19 of connector stud 11 of frame 10. This arrangement is configured so that when the moveable arm 32 is forced against stud 11, the latching mechanism 33 holds one of the teeth 19, thereby making separation of the two frames 10, 20 virtually impossible without the destruction of at least one of those frames. As such, when moveable arm 32 is locked into this position, the frames are effectively in a permanent mounting arrangement.

The resiliency of the material that constitutes both frames 10 and 20, exerts a spring-like tension against both the panel and the window held within a panel aperture when full connection is made between frames 10 and 40. The spring-like capability applies for a wide range of panel thicknesses.

The teeth 19 on connector stud 11 are arranged across the entirety of the width of a major surface of the connector stud as depicted in FIG. 7. The teeth 21 are arranged in rows over a substantial length of connector stud 20, also as depicted in FIG. 7. Each tooth is approximately 0.052 inches in height, and in the example depicted in FIG. 7 has an angle of approximately 60° from horizontal. The fact that the teeth 19 extends over the majority of the length of connector stud 11 allows a wide range of window and panel thicknesses to be accommodated by the present invention since a good connection can be made on any of the teeth deployed along the length of connector stud 11.

In the example depicted in FIG. 7, the connector stud 11 is 1.8 inches in length and has teeth 21 arranged along most of it's length with each tooth extending across the entire width of a major surface of the connector stud. The connector stud 11 is preferably made of the same resilient material as is used for the rest of frame 10. Consequently, each connector stud will have a certain amount of flexibility, permitting it to more easily be fitted into a complementary hollow receiver 30 on the other frame 20.

In the example depicted each of the connector studs 11 is approximately 1.48 inches wide. The connector studs as depicted in FIG. 7 are approximately 0.25 inches thick. It should be remembered that the aforementioned dimensions are merely exemplary, having been taken from one model of mounting frame made in accordance with the present invention. The dimensions are provided only to suggest relative sizes and the scope of a particular model of the inventive mounting frame as it is currently being employed.

In one alternative embodiment, as depicted in FIG. 10, the connector stud 11 may be formed to have an angled surface of approximately 30° at the tip of the stud. This angled surface serves to more easily allow the connector stud 11 to slide into its complementary hollow receiver 30. While this feature does aid the operability of the present invention, it is not necessary thereto.

FIG. 10 depicts the mating of the two frames 10, 20 by virtue of the connection of the teeth 21 of connector stud 11 with a latching structure 33 in hollow receptacle or receiver 30. The hollow receiver is supported by the rest of frame 20 and has side walls 31, fixed back surface 29, moveable arm 32, and the lip of aperture 28, as depicted in FIGS. 7 and 8. Preferably, the hollow receiver 30 is made of the same flexible material as the rest of the frame 20 so that a certain tolerance is permitted in the fitting of the connector stud 11 into the hollow receiver 30. The flexibility of both the connector stud 11 and the hollow receiver 30 make installation of windows within all types of panels far easier to carry out than would be possible with entirely rigid members on frames 10, 20. The fact that there is flexibility in the connector stud 20 and hollow receiver 30 structures means that the window mounting can absorb a high amount of stress without frames 10, 20 separating from each other.

Even when there is a certain amount of movement of the two frames 10, 20 with respect to each other, the connections remain firm due to the width of teeth 21 over the surface of connector stud 11. Latching structure 33 also extends for the entire width of teeth 19 so that when the latching structure interfaces with a particular tooth, there is relatively large interface surfaces (horizontal plane and 60° plane) between them. As a result, even though the two frames 10, 40 flex and move with respect to each other, the connection between the two frames 10,20 remains secure.

Further, the latching security can be obtained by the presence of side walls of connector stud 11, which fit into hollow spaces on either side of the latching structure 33. The sidewalls 35 help prevent twisting of the connector stud 20 with respect to the latching structure 32 thereby holding the latching structure firmly against a selected tooth 21. Also, the angle of inclination of the latching structure 33 (60° from horizontal) matches that of the teeth so that the maximum amount of interface surface between the teeth 21 and the latching structure is possible.

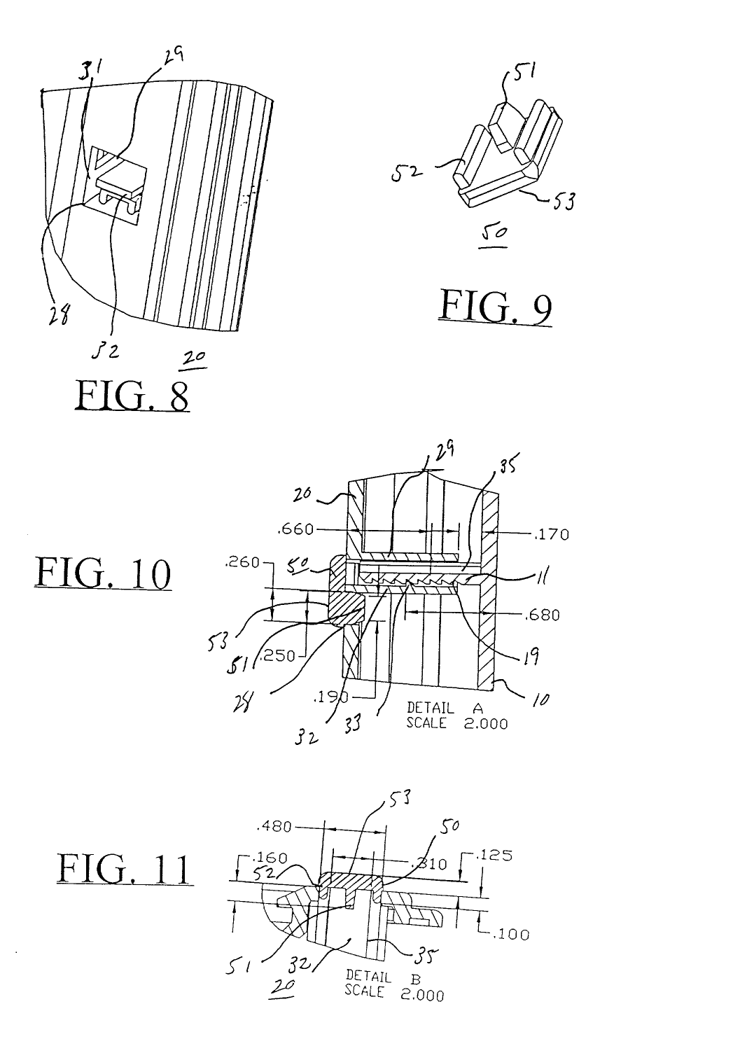

Moveable arm 32 can maintain a tight interface between latching structure 33 and one of the teeth 19 only if moveable arm 32 is held in the proper position. Otherwise, the arm will tend to slide away from the teeth 19, thereby releasing stud 11 from hollow receptacle 30. Accordingly, moveable arm 32 must be locked into place in order for a proper connection between frame 10, 20 can take place. In order to hold moveable arm 32 in place, a locking insert 50, as depicted in FIG. 9, is provided. When locking of the connector stud 11 in hollow receptacle 30 is desired, the locking insert 50 is put into aperture 28. Center leg 51 of locking insert 50 serves to contact moveable arm 32 and press it into place so that the latching device 33 is in close contact with one of the teeth 19 of connector stud 11. Outer legs 52 fit closely between side walls 31 of the hollow receiver 30. Thereby, the locking insert 50 is held firmly in place. The length and width of the side legs 52 are configured so that the locking insert 50 fills aperture 28 and is held snuggly therein while forcing moveable arm 32 into a position where connector stud 11 is locked firmly within the hollow receptacle 30. In this manner, a permanent connection can be made between frames 10 and 20.

Because of the smooth top 53 of locking insert 50, a relatively smooth and impervious surface can be presented on the exposed side of frame 20. Nonetheless locking insert 50 is easily removed with a screwdriver or similar tool, thereby exposing moveable arm 32 so that connector stud 11 can be released if desired. If this option is not desired, locking insert 50 can be glued in place within aperture 28 or permanently connected using any number of different bonding techniques.

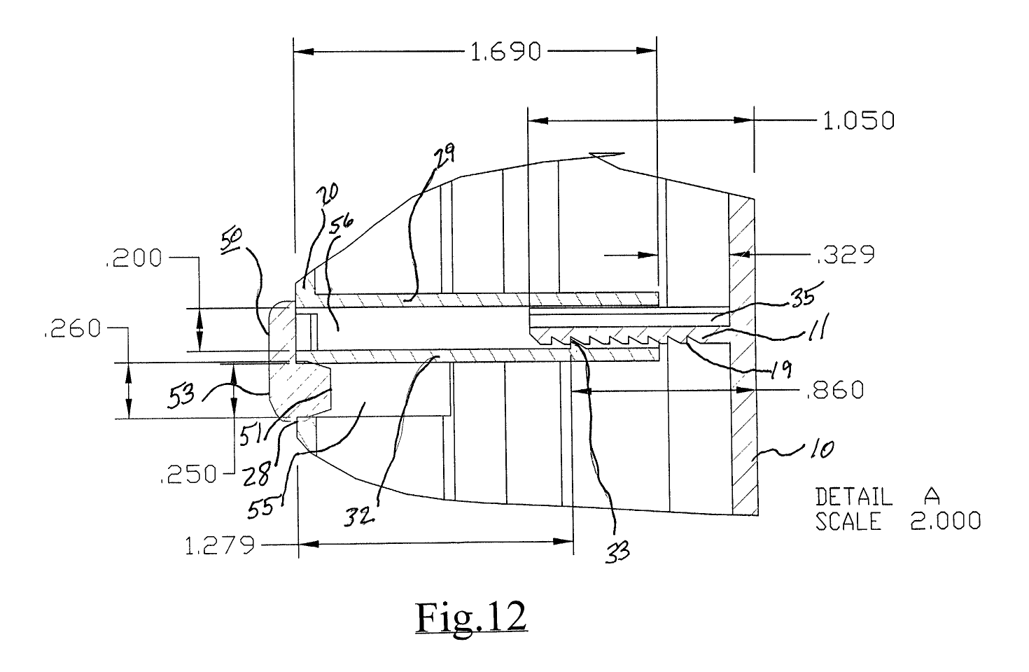

A side cross sectional view of locking insert 50 is depicted in FIG. 10. This arrangement demonstrates how the middle leg 51 of locking insert 50 is forced against moveable arm 32, thereby locking connecting stud 11 into place by virtue of latching structure 33. FIG. 11 depicts the cross sectional view of locking insert 50 as viewed 90° from that of FIG. 10.

FIG. 12 is an expanded version of FIG. 10, and is used to more specifically depict two cavities 55, 56. When the middle leg 51 of locking insert 50 is inserted into cavity 55, the moveable arm 32 is forced against connector stud 11. When this happens, latching structure 33 interfaces with one of the teeth 19 firmly holding the two frames 10,20 together. As long as locking insert 50 remains in this position, the connection between the two frames is permanent. However, there are times when it is necessary to detach frames 10,20 from each other, even if the connection was originally meant to be permanent.

Release of the two frames 10,20 can be facilitated simply by slipping a screwdriver under locking insert 50 and working the middle leg 51 out of cavity 55. While the removal of locking insert 50 permits the movement of removeable arm 32 away from connector stud 11, it does not guarantee that this will happen. Rather, very often the flexible materials constituting moveable arm 32 and connector stud 11 have become sufficiently deformed that latching structure 32 will still interface with one of the teeth 19. If this occurs at a number of points along frames 10,20, then separation of the two frames can become very problematical. The solution provided by this embodiment of the present invention is simple and effective. Locking insert 50 need be rotated only 180° from the position shown in FIG. 12. Then middle leg 51 is inserted into space 56, thereby driving removable arm 32 away from connecting stud 11. This will occur despite any deformity that has occurred in removable arm 32, or any sticking that has occurred between latching structure 33 and teeth 19. While the middle leg 51 remains in cavity 56, there can be no locking of the two frames together. If locking of the two frames 10,20 is required, locking insert 50 is simply removed from cavity 56 and replaced into cavity 55 as shown in FIG. 12.

The inventive mounting device has the capability of accommodating an increased range of windows by making alterations in the size and the shape of the detents or indents 16 (as depicted in FIG. 4) for both frames 10, 20. The detents 16 (FIG. 4) can be adjusted by manually shaving the planer structure 12, or by forming the detents as part of the overall molding process in which frame 10 is manufactured. The use of detents 16 allow the use of frame materials that are somewhat more pliable and might not be practical without the use of the indents. The use of detents can be made on any arm or holding structure that interfaces with a panel. Very often greater flexibility can be obtained by manufacturing the frames 10, 20 to have custom holding structures 18,27. In the alternative custom extended holding structures can be retrofitted to the arms of the frames.

While detents such as 16 in FIG. 4, proved to be useful, there are other techniques for more firmly gripping the panels. For example, in FIG. 7, on arms 42 and 41 gripping surfaces 43 and 44 have special structures to more firmly grip the relevant panel. Such structures can be rubber or plastic fibers that create friction between a fiberglass frame and a glass window. Such additional gripping devices can be used on any of the arms or holding surfaces in order to facilitate a better connection between the frame and the panels. Very often, such gripping devices also serve as weather seals.

Although a number of embodiments have been described by way of example, the present invention is not limited thereby. Accordingly, the present invention should be construed to include any and all variations, permutations, modifications, adaptations and embodiments that would occur to one skilled in this technology once having been taught the present invention by this application. Therefore, the present invention should be construed as being limited only by the following claims.

We claim:

1. A mounting device for holding a first panel within an aperture in a second panel, said mounting device comprising:
(a) a first flexible frame having a first base structure, a first flexible holding structure extending from said first base structure and arranged to overlap said first panel, a second flexible holding structure extending from said first base structure and arranged to overlap said second panel, and a plurality of connector studs, each said connector stud having at least one major surface extending along an axis substantially perpendicular to said first base structure, each said connector stud having a plurality of teeth arranged across a width of said connector stud and subsequently along a longitude of said major surface; and,
(b) a second flexible frame having a third flexible holding structure arranged to overlap said first panel and a fourth flexible holding structure arranged to overlap said second panel, and a plurality of hollow receivers arranged to receive a complementary connector stud from said first frame, each said hollow receiver having an interior latch structure arranged to interface with and grip to at least one of said teeth of said complementary connector stud.

2. The mounting device of claim 1, whereby said first and second frames exerts spring-like pressure against said first panel and said second panel when said first and second frames are connected together by virtue of said connector studs extending into and latching with complementary hollow receivers.

3. The mounting device of claim 2, wherein said first panel and said second panel are of different thicknesses.

4. The mounting device of claim 3, wherein said first and third flexible holding structures are longer than said second and fourth flexible holding structures, respectively.

5. The mounting device of claim 2, wherein respective teeth and respective latching structures of said complementary connector studs and hollow receivers operate to connect said first and second frames in a permanent manner.

6. The mounting device of claim 5, where each said tooth extends substantially an entire width of said major surface of said connector stud and said latch structure of a complementary hollow receiver extends substantially the same distance as said teeth.

7. The mounting method of claim 6, wherein said latching structure interfaces with a selected tooth of said complementary connector stud on at least two surfaces of said latching structure and two surfaces of said selected tooth.

8. The mounting device of claim 7, wherein said frames comprise plastic.

9. The mounting device of claim 7, wherein said frames comprise a metal having spring-like characteristics.

10. The mounting device of claim 7, wherein said frames comprise fiberglass.

11. The mounting device of claim 7, wherein said frames comprise rubber.

12. The mounting device of claim 7, wherein said first frame further comprises indentations for receiving first and second panels.

13. The mounting device of claim 7, wherein each said hollow receiver comprises two side surfaces formed perpendicular to said major surface of said complementary connector stud, and arranged on either side of said teeth.

14. The mounting device of claim 7, wherein said first panel comprises a window.

15. The mounting device of claim 7, wherein said teeth are arranged on alternate major surfaces of adjacent connector studs.

16. The mounting device of claim 7, wherein said second panel is a window.

17. The mounting device of claim 1, further comprising insertion means for locking and releasing for holding said connector studs into respective ones of said hollow receivers.

18. A mounting device for holding a first panel within an aperture in a second panel, said mounting device comprising:
(a) a first flexible frame having a first flexible holding structure arranged to overlap said first panel, and a second flexible holding structure arranged to overlap said second panel, and a plurality of connector studs; and,
(b) a second flexible frame having a third flexible holding structure arranged to overlap first panel, and a fourth flexible holding structure arranged to overlap said second panel, and a plurality of receptacles arranged to receive complementary connector studs from said first flexible frame;
whereby said first and second flexible frames exert spring-like pressure against said first and second panels when the first and second frames are connected together by virtue of said connector studs and said receptacles.

19. The mounting device of claim 18, further comprising insertion means for locking and releasing said connector studs in said receptacles.

20. The mounting device of claim 18, wherein said first and second panels are of different thicknesses.

21. The mounting device of claim 20, wherein said second and fourth flexible holding structures are longer than said first and third flexible holding structures, respectively.

22. The mounting device of claim 18, wherein said first, and third, flexible holding structures are arranged outward from said connector studs and said receptacles at a 90° angle.

23. The mounting device of claim 18, wherein said third and fourth holding structures extend outward from said frame at an angle of greater than 90° from said connecting stud.

24. The mounting device of claim 18, wherein said first and second flexible frames comprise of plastic.

25. The mounting device of claim 18, wherein said first and second flexible frames comprise a metal having spring-like characteristics.

26. The mounting device of claim 18, wherein said flexible frames comprise fiberglass.

27. The mounting device of claim 18, wherein said flexible frames comprise rubber.

28. The mounting device of claim 18, wherein said connecting means comprise a hook-like structure interfacing with an aperture.

29. The mounting device of claim 18, wherein said second flexible frame comprises a U-shaped structure.

30. A mounting device for holding a first panel within an aperture in a second panel, said mounting device comprising:
(a) a first flexible frame having a first base structure, holding structures extending from said base structure for holding both said first and second panels, and a plurality of connecting studs;
(b) a second flexible frame having a second base structure, and holding structures extending from said second base structure for holding said first and second panels, and a plurality of connecting receptacles arranged to receive complementary connector studs, each said connecting receptacle comprising a latching means for holding said complementary connector stud; and,
(c) insertion means for locking and releasing said connector studs within said complementary connector receptacles.

31. The mounting device of claim 30, said connector stud comprises a series of horizontally extending teeth, and said latching means comprise a hook-like structure interfacing with at least one of said teeth to hold said connector stud within said receptacle.

32. The mounting device of claim 31, wherein said connecting receptacle comprises at least one moveable wall, said moveable wall being exposed by an aperture in said second base of said second frame.

33. The mounting device of claim 32, wherein said insertion means is arranged to plug said aperture of said second flexible base structure in a first position thereby locking said latching means to said connector stud.

34. The mounting device of claim 33, wherein removal of said insertion means from said first position allows release of said latching means from said at least one tooth of said connector stud.

35. The mounting device of claim 34, wherein said insertion means is arranged to plug said aperture of said flexible base structure in a second position when forcing said latching means away from at least one of said teeth.
